(19) United States
(12) Patent Application Publication
(10) Pub. No.: US 2002/0164197 A1
(43) Pub. Date: Nov. 7, 2002

(54) Pivotal connector for scanner

(76) Inventor: Ta Yi Lee, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/826,939

(22) Filed: Apr. 6, 2001

(51) Int. Cl. F16C 11/00

(52) U.S. Cl. 403/65

(57) ABSTRACT

A pivotal connector for scanner comprises a plurality of pivotal cavities concavely arranged on one side of a main body of the scanner, and a plurality of pivotal bodies convexly arranged on one side of a document cover of the scanner and having locations corresponding to those of the pivotal cavities. Each pivotal cavity has two guiding grooves on both sidewalls thereof, and each guiding groove has a recess connected to lateral side of the main body. The pivotal body has two pivotal rods extended from two sidewalls thereof and are placed into the guiding grooves through the recesses. The pivotal rods are movable in the guiding grooves such that the document cover can be tightly attached on a thick document to be scanned.

### FIELD OF THE INVENTION

The present invention relates to a pivotal connector for scanner, especially to a pivotal connector with simple structure and easy assembling.

### BACKGROUND OF THE INVENTION

As shown in FIG. 1, a prior art scanner generally comprises a scanner main body 1a and a document cover 2a and the scanner main body 1a is assembled with the document cover 2a by a pivotal member such as a hinge 10a. Therefore, the document cover 2a is opened and closed with respect to the scanner main body 1a by the help of the hinge 10a. However, the use of the hinge 10a has a restriction to the allowable displacement of the document cover 2a. The document cover 2a cannot be tightly attached on the document to be scanned if the document is too thick. The scanner window is very difficult to focus the document to be scanned. As a result, the scanned image is distorted.

Moreover, the hinge 10a in prior art scanner is generally assembled on a pivotal shaft 20a such that the document cover 2a can be rotated for opening and closing. However, after repeatedly use, the document cover 2a may be detached from the scanner main body 1a and the hinge 10a may be broken.

The resolution and the image quality of the scanner have progressive improvement recently, and the price of the scanner is also decreased. Therefore, the scanner having extra advantages such as reduced cost and enhanced function will become more competitive.

### SUMMARY OF THE INVENTION

It is the object of the invention to provide a pivotal connector with simple structure and easy assembling.

To achieve the above object, the pivotal connector for scanner comprises a plurality of pivotal cavities concavely arranged on one side of the main body and a plurality of pivotal bodies convexly arranged on one side of the document cover and having locations corresponding to those of the pivotal cavities. Each pivotal cavity has two guiding grooves on both sidewalls thereof; and each guiding groove has a recess connected to lateral side of the main body. Each pivotal body has two pivotal rods extended from two sidewalls thereof, and each pivotal rod passes through the recess and is placed within the guiding groove.

The various objects and advantages of the present invention will be more readily understood from the following detailed description when read in conjunction with the appended drawing, in which:

### BRIEF DESCRIPTION OF DRAWING

FIG. 1 shows a perspective view of a prior art pivotal connector;

FIG. 2 shows the perspective view of the pivotal connector for scanner according to a preferred embodiment of the present invention;

FIG. 2A is the perspective view of the pivotal body according to a preferred embodiment of the present invention;

FIG. 2B is the perspective view of the pivotal cavity according to a preferred embodiment of the present invention;

FIG. 3 explains the assembling of the present invention;

FIG. 4 is a sectional view of the assembled pivotal connector for scanner according to a preferred embodiment of the present invention

FIG. 5 shows the pivotal connector for scanner in open state;

FIG. 6 shows the pivotal connector for scanner when the scanner is used to scan a thick document.

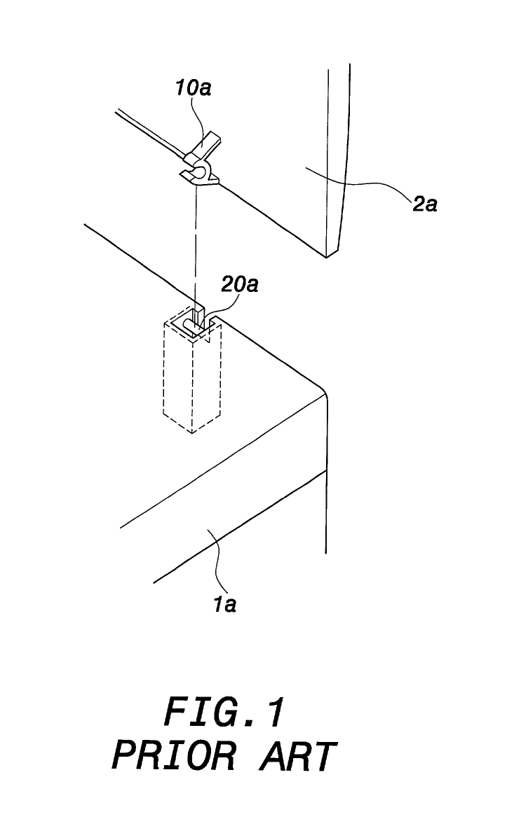

### DETAILED DESCRIPTION OF THE INVENTION

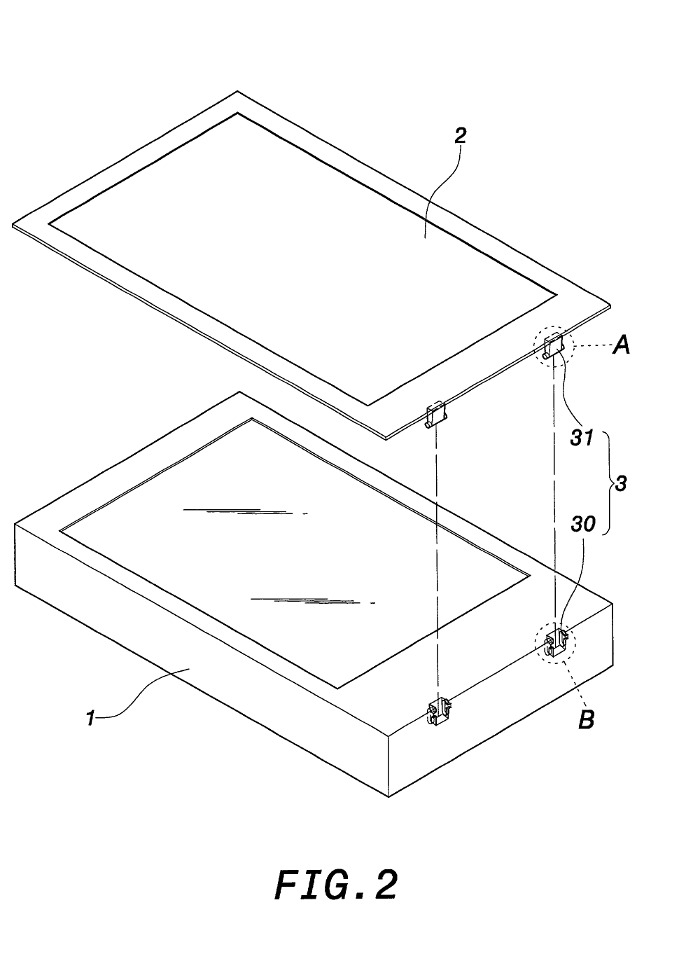

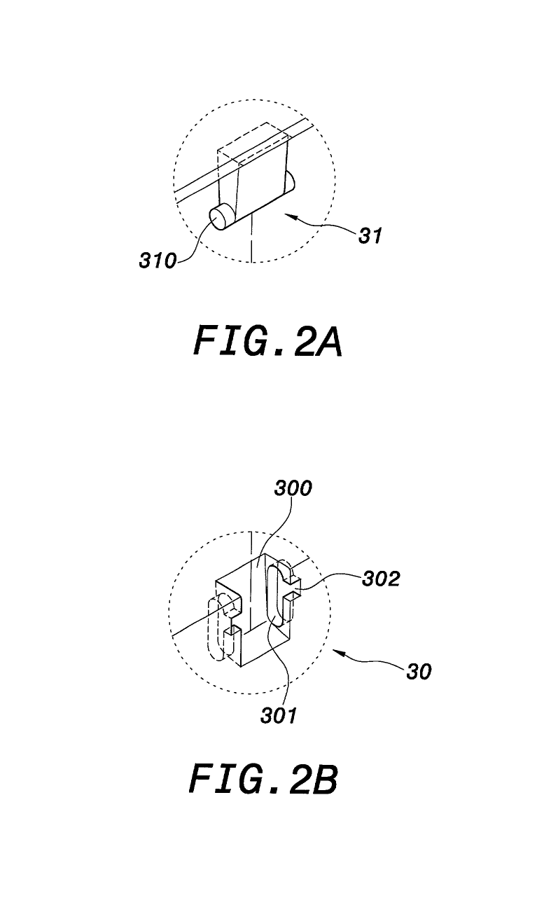

FIG. 2 shows the perspective view of the pivotal connector for scanner according to a preferred embodiment of the present invention. The scanner in this preferred embodiment comprises a main body 1, a document cover 2 and a pivotal connector 3, wherein the document cover 2 is assembled atop the main body 1 by the pivotal connector 3, and the document to be scanned is placed between the main body 1 and the document cover 2. In the present invention, the pivotal connector 3 comprises two pivotal cavities 30 arranged on one top side of the main body 1 as shown in FIG. B and two pivotal bodies 31 projectingly arranged on one bottom side of the document cover 2 as shown in FIG. 2A. The locations of the two pivotal bodies 31 are corresponding to those of the pivotal cavities 30.

The pivotal cavities 30 each has passage 300 vertically connected to the topside of the main body 1 and horizontally connected to the lateral side of the main body 1. The passage 300 has two guiding grooves 301 on both sides thereof. The vertical height of the guiding groove 301 is corresponding to the maximum thickness of the document to be scanned. Moreover, the guiding groove 301 has a recess 302 horizontally connected to the lateral sides of the main body 1.

The pivotal bodies 31 are integrally formed with the document cover 2 and each has two pivotal rods 310 on two lateral sidewalls thereof. The two pivotal rods 310 are inserted into the recesses 302 of the two guiding grooves 301 such that two pivotal rods 310 can be placed into the two guiding grooves 301 of the pivotal cavities 30.

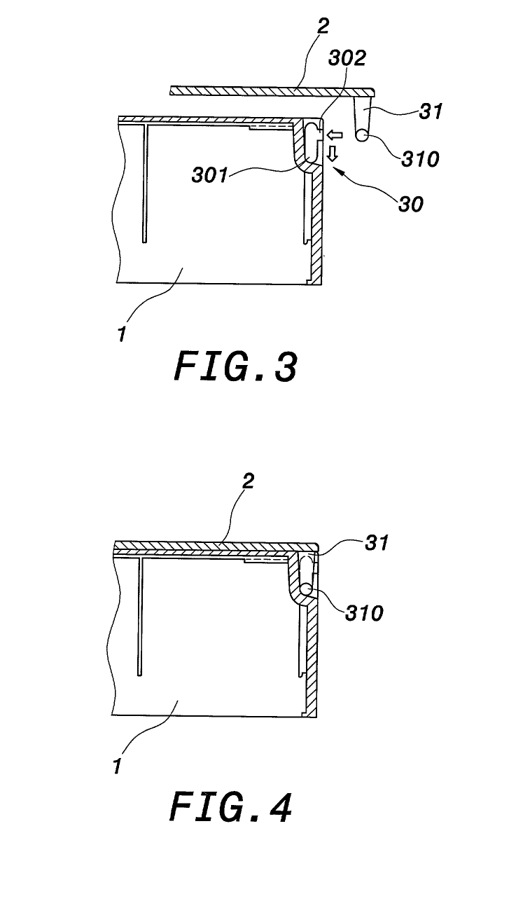

To assemble the document cover 2 on the main body 1, the document cover 2 is firstly placed horizontally with the pivotal bodies 31 pointing downward, as shown in FIG. 3. Afterward, the pivotal bodies 31 enter the passages 300 of the pivotal cavities 30 along horizontal direction. At the same time, the two pivotal rods 310 on both sides of the pivotal body 31 also pass the recesses 302 of the two guiding grooves 301. After the two pivotal rods 310 passing the recesses 302 of the two guiding grooves 301, the pivotal bodies 31 fall down due to the weight of the document cover 2 and the two pivotal rods 310 on both sides of the pivotal body 31 are moved to bottom of the two guiding grooves 301, as shown in FIG. 4.

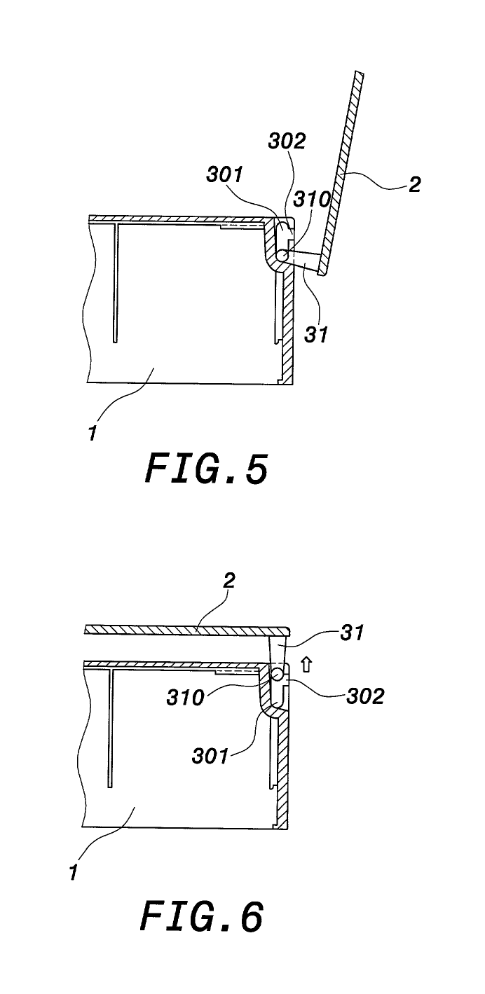

When the scanner with the pivotal connector 3 according to the present invention is used for scanning a document, the document cover 2 is rotated with the pivotal rods 310 as pivot, wherein the pivotal rods 310 are initially placed on bottom of the guiding grooves 301. The document cover 2 is rotated with the pivotal rods 310 as pivot until the pivotal bodies 31 abut bottom side of the pivotal cavities 30 as shown in FIG. 5. When the scanner is used to scanner a thicker document and the document cover 2 is to be attached on the thicker document, the pivotal rods 310 are raised in the guiding grooves 301 and the positions of the pivotal rods 310 in the guiding grooves 301 depend on the thickness of the document as shown in FIG. 6. After the document is scanned, the document cover 2 is rotated to open and the pivotal bodies 31 are moved to bottom of the pivotal cavities 30. Moreover, the pivotal rods 310 are retained by the top wall of the guiding grooves 301, the document cover 2 will not be detached from the main body 1.

To sum up, the pivotal connector 3 according to the present invention has following advantages:

(1) The pivotal bodies 31 are integrally formed with the document cover 2 and can be directly fit with the main body 1. The structure of the pivotal connector is simple and the cost thereof is low.

(2) The pivotal rods 310 of the pivotal bodies 31 are movable within the guiding grooves 301 of the pivotal cavities 30, the scanner with the pivotal connector 3 according to the present invention can be used to scan document with large thickness.

(3) The assembling of the pivotal connector 3 according to the present invention is easy.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A pivotal connector for scanner comprising:
a plurality of pivotal cavities concavely arranged on one side of the main body, each pivotal cavity having two guiding grooves on both sidewalls thereof, each guiding groove having a recess connected to lateral side of the main body, and
a plurality of pivotal bodies convexly arranged on one side of the document cover and having locations corresponding to those of the pivotal cavities, each pivotal body having two pivotal rods extended from two sidewalls thereof, each pivotal rod passing through the recess and placed within the guiding groove.

2. The pivotal connector for scanner as in claim 1, wherein the pivotal cavity is a dent connected to topside and lateral side of the main body.

3. The pivotal connector for scanner as in claim 1, wherein the guiding groove has a vertical height corresponding to the maximum thickness of document to be scanned.
